(19) United States
(12) Patent Application Publication
(10) Pub. No.: US 2014/0346403 A1
(43) Pub. Date: Nov. 27, 2014

(54) CARBON MONOXIDE SHIFT REACTION APPARATUS AND CARBON MONOXIDE SHIFT REACTION METHOD

(71) Applicant: MITSUBISHI HEAVY INDUSTRIES, LTD., Tokyo (JP)

(72) Inventors: Koji Higashino, Tokyo (JP); Toshinobu Yasutake, Tokyo (JP); Shuji Fujii, Tokyo (JP); Masanao Yonemura, Tokyo (JP); Makoto Susaki, Tokyo (JP); Kaori Yoshida, Tokyo (JP); Yoshio Seiki, Tokyo (JP); Atsuhiro Yukumoto, Tokyo (JP)

(73) Assignee: MITSUBISHI HEAVY INDUSTRIES, LTD., Tokyo (JP)

(21) Appl. No.: 14/366,588

(22) PCT Filed: Dec. 13, 2012
(86) PCT No.: PCT/JP2012/082329

§ 371 Date: Jun. 18, 2014

(30) Foreign Application Priority Data
Dec. 22, 2011 (JP) 2011-281522

(51) Int. Cl. C01B 3/16

(52) U.S. Cl. CPC C01B 3/16; C01B 2203/0283; C01B 2203/0883; C01B 2203/169
USPC 252/373; 422/162

(57) ABSTRACT

A CO shift reaction apparatus is configured to suppress degradation of catalytic activity of a CO shift catalyst containing molybdenum and prolong the life of the catalyst. A CO shift reaction method uses the CO shift reaction apparatus. The CO shift reaction apparatus is configured to reform carbon monoxide contained in gas and includes a CO shift catalyst containing molybdenum; a reactor at least comprising: a gas inlet for introducing gas; a CO shift catalyst layer filled with the CO shift catalyst and through which the introduced gas passes; and a gas outlet for discharging the gas which has passed through the CO shift catalyst layer; and cooling means configured to cool the CO shift catalyst layer.

### TECHNICAL FIELD

The present invention relates to a CARBON MONOXIDE (CO) shift reaction apparatus and a CO shift reaction method which uses the CO shift reaction apparatus.

### BACKGROUND ART

In recent years, much attention is focused on effectively using coal as an effective method for solving energy problems. Highly advanced technology has been used, such as a technique for gasifying coal and a technique for purifying the gasified coal, in order to convert coal into a high value-added energy medium.

The process of purifying coal-gasified gas includes a carbon monoxide (CO) shift process, in which CO is allowed to react with water to be converted into a hydrogen molecule (H₂) and carbon dioxide (CO₂) (Formula 1).

In addition, the process of purifying coal-gasified gas can employ a process configuration in which dedusted material gas is supplied to CO shift reactors as illustrated in FIG. 1 as an example and another process configuration including a recovery apparatus provided upstream of CO shift reactors and configured to remove sulfur (H₂S, etc.) as illustrated in FIG. 2 as another example.

[Expression 1]

CO+H₂O→CO₂+H₂ (1)

In addition, a system has been proposed in which purified gas obtained by gasifying and purifying coal is applied to synthesis of chemicals such as methanol or ammonium or applied directly to generation of power, and examples of such a power generation system include an integrated coal gasification combined cycle (IGCC) system (Patent Document 1, for example). More specifically, the IGCC system is a system in which coal is converted by a gasification furnace into combustible gas and power is generated by using a combination of a gas turbine and a steam turbine using the coal-gasified gas as the fuel.

Examples of catalysts commonly used in coal-gasified gas purification processes as CO shift reaction promotion catalysts include a CO shift catalyst which contains molybdenum and cobalt as its active components carried by alumina oxide (the CO shift catalyst may be hereafter referred to as a “Co—Mo/Al₂O₃ catalyst”). The Co—Mo/Al₂O₃ catalyst has a high activity at a high temperature (ranging from about 350° C. to 500° C.); however, the catalyst performance may degrade at a high reaction temperature due to disposition of carbonaceous substances (i.e., coking), and also the CO conversion rate may degrade in terms of the chemical equilibrium, which may be disadvantageous to the system. In order to address these problems, conventional methods have been used in which steam is added in excess amount equal to or greater than the chemically correct mixture ratio for CO shift reactions, e.g., in an amount with which the H₂O/CO ratio would become twice or more higher than the stoichiometric ratio; however, development of methods that can be performed with less steam to be added has continued because the running costs for the above-described method are high.

In order to reduce the excessive amount of steam to be added, a CO shift catalyst has been proposed, which contains molybdenum and cobalt as its active components carried by titanium dioxide (the CO shift catalyst may be hereafter referred to as a “Ni—Mo/TiO₂ catalyst”) having a high activity even at low temperatures (ranging from about 200° C. to 350° C.) (Patent Document 2). However, because CO shift reactions are exothermal reactions, if a common adiabatic reactor is used, the temperature around the outlet of the reactor becomes high (ranging from about 450° C. to 550° C.), and therefore, neither the problem of degradation of catalyst durability occurring due to coking nor the disadvantage with respect to chemical equilibrium can be solved.

### CITATION LIST

### Patent Document

[Patent Document 1] Japanese Patent Application Publication No. 2004-331701

[Patent Document 2] Japanese Patent Application No. 2010-039412

### SUMMARY OF INVENTION

### Technical Problem

If such an excellent catalyst performance can be maintained for a longer time, it would become possible to maintain the conditions suitable for running CO shift reactions, and as a result, the efficiency of gas purification processes can be improved. Therefore, it is a new task to be performed in the technical field involving CO shift reactions to suppress coking which may occur during operation of a reaction apparatus with a small amount of steam and to prolong the life of the catalyst.

### Solution to Problem

Focusing on the prolongation of the life of catalysts described above, the inventors have reexamined the configurations of CO shift reaction mechanisms and CO shift reaction apparatuses and CO shift reaction methods.

As a result of the reexamination, the inventors have obtained a finding that if a CO shift catalyst for coal-gasified gas containing Mo, such as a Ni—Mo/TiO₂ catalyst, is used, the temperature of the reaction apparatus influences the catalytic activity. Considering that CO shift reactions might influence the variation of the temperature of a reaction apparatus because CO shift reactions are exothermal reactions, the inventors have focused on and examined the behavior of the temperature of a reaction apparatus which varies in accordance with the progress of CO shift reactions on the basis of the above-described finding. As a result, it has been found that chain of heating occurs as the coal-gasified gas is heated by a CO shift reaction, as the gas having been heated to a high temperature due to the CO shift reaction heats the catalyst in the reaction apparatus, and as the temperature of the catalyst thereby rises, and that the temperature of the catalyst may thus exceed a predetermined temperature, which consequently brings about an increase in the amount of coking and affects the life of the catalyst.

The inventors have carried out various experiments on the basis of these results, and thereby the present invention has been completed on the basis of findings obtained as a result of the examinations such that the life of a CO shift catalyst for coal-gasified gas containing Mo, such as a Ni—Mo/TiO₂ catalyst, can be prolonged if the temperature of the catalyst is maintained at a predetermined temperature or below by controlling the temperature of gas which may rise due to the CO shift reaction.

Accordingly, in a first aspect of the present invention, a CO shift reaction apparatus configured to reform carbon monoxide contained in gas at least includes a CO shift catalyst containing molybdenum; a reactor at least including a gas inlet for introducing gas; a CO shift catalyst layer filled with the CO shift catalyst and through which the introduced gas passes; and a gas outlet for discharging the gas which has passed through the CO shift catalyst layer; and cooling means configured to cool the CO shift catalyst layer.

According to a second aspect of the present invention, in a CO shift reaction method which uses the CO shift reaction apparatus of the first aspect, a temperature of the CO shift catalyst is maintained by the cooling means at 350° C. or below.

According to a third aspect of the present invention, a CO shift reaction apparatus configured to reform carbon monoxide contained in gas at least includes a CO shift catalyst containing molybdenum; a plurality of adiabatic reactors at least including a gas inlet for introducing gas; a CO shift catalyst layer filled with the CO shift catalyst and through which the introduced gas passes; and a gas outlet for discharging the gas which has passed through the CO shift catalyst layer; at least one heat exchanging means configured to cool the gas discharged through the gas outlet; at least one steam supply means configured to supply steam to the CO shift catalyst layer; and at least one gas pipe which connects the plurality of adiabatic reactors in series.

According to a fourth aspect of the present invention, in a CO shift reaction method which uses the CO shift reaction apparatus according to the third aspect, a CO shift reaction is controlled by adjusting an amount of steam to be supplied to the CO shift catalyst layer by using the steam supply means and the temperature of the CO shift catalyst is maintained at 350° C. or below by cooling the gas by using the heat exchanging means so that the gas discharged through the gas outlet is 350° C. or below.

### Advantageous Effects of Invention

According to the CO shift reaction apparatus of the present invention and the CO shift reaction method which uses the CO shift reaction apparatus, coking on a Ni—Mo/TiO₂-based catalyst is suppressed, and thereby, the life of the catalyst can be prolonged.

### BRIEF DESCRIPTION OF DRAWINGS

FIG. 1 is an outline drawing which illustrates the overall gas purification process.

FIG. 2 is an outline drawing which illustrates the overall gas purification process according to an embodiment different from that illustrated in FIG. 1.

FIG. 3 is a cross section which illustrates an embodiment of the CO shift reaction apparatus according to the present invention.

FIG. 4 is a schematic diagram which illustrates a CO shift reaction apparatus which uses adiabatic reactors according to an embodiment different from that illustrated in FIG. 3.

FIG. 5 is a schematic diagram illustrating a CO shift reaction apparatus which uses an adiabatic reactor according to an embodiment different from that of the present invention.

FIG. 6 illustrates results of measurement of the temperature of a CO shift catalyst used in Example 1.

FIG. 7 illustrates results of measurement of the temperature of a CO shift catalyst used in Example 2.

FIG. 8 illustrates results of measurement of the temperature of a CO shift catalyst used in Comparative Example 1.

### DESCRIPTION OF EMBODIMENTS

Hereinbelow, a CO shift reaction apparatus according to the present invention and a CO shift reaction method which uses the CO shift reaction apparatus will be described in detail.

First, the CO shift reaction apparatus according to the present invention is an apparatus configured to reform carbon monoxide contained in gas in the manner expressed by the above Formula (1). Gas containing carbon monoxide and intended to be reformed may be used as the gas to be reformed, and examples of such gas to be reformed include combustible gas, etc. containing CO and H₂ as its main components, which can be obtained by adding oxygen, steam, etc. to coal.

In addition, the CO shift reaction apparatus is configured to at least include a reactor and cooling means. The reactor at least includes a gas inlet, a CO shift catalyst layer filled with a CO shift catalyst, and a gas outlet, and the gas is introduced through the gas inlet into the inside of the reactor and passes through the CO shift catalyst layer, and thus a CO shift reaction progresses and then the gas is discharged through the gas outlet to the outside of the reactor.

The CO shift catalyst filled into the CO shift catalyst layer is a CO shift catalyst for purification of coal-gasified gas containing Mo. It is more preferable that the CO shift catalyst contain nickel, and it is yet more preferable that the CO shift catalyst be carried by titanium dioxide. Examples of the preferable catalyst like this include a Ni—Mo/TiO₂ catalyst having activity at low temperatures.

Because Mo is included as one of the main components, the catalyst is capable of promoting the CO shift reaction in the presence of H₂S. An expression of chemical equilibrium for sulfurization of a Ni—Mo/TiO₂ catalyst will be described with reference to the following Formula (2), which expresses a reaction by which molybdenum oxide reacts with hydrogen sulfide to generate molybdenum sulfide.

[Expression 2]

MoOx+xH₂S [symbol] MoSx+xH₂O (x=0-3) (2)

In the activated state, the CO shift catalyst includes a mixture of molybdenum oxide and molybdenum sulfide. The catalytic activity is correlated with the ratio of the molybdenum sulfide, i.e., the catalytic activity becomes lower as the ratio of molybdenum sulfide becomes lower. According to Le Chatelier's law, if the partial pressure of H₂S inside the reactor is low, the equilibrium composition is inclined to the left term of the above-described Formula (2), and accordingly, the ratio of molybdenum sulfide tends to decrease and the catalytic activity tends to become lower. Because subcomponent elements such as Co and Ni enable stabilization of molybdenum sulfide under conditions in which the concentration of H₂S is low, the shift of the equilibrium composition to the left term of the above-described Formula (2) is suppressed even if the partial pressure of H₂S is low, and as a result, the catalytic activity can be maintained.

With respect to cooling means included in the CO shift reaction apparatus, means capable of cooling the CO shift catalyst layer to prevent the catalyst temperature from becoming high can be used, and examples of such cooling means include means for water-cooling the periphery of the CO shift catalyst layer and means for cooling the periphery of the CO shift catalyst layer by using other cooling media.

In addition, the CO shift reaction apparatus can also include apparatuses and means such as steam supply means, means for supplying coolant gas, measuring instruments (a temperature sensor, a concentration sensor, and a pressure sensor), a CO shift reactor for backup, and an apparatus configured to supply nitrogen, which is to be used when abnormality occurs. For example, the steam supply means may be means capable of supplying water necessary for the CO shift reaction as steam, which is a state of water appropriate for the reaction, and examples of the steam supply means described above include a steam supply apparatus, etc.

With respect to the CO shift reaction method which uses the CO shift reaction apparatus described above, it is preferable to maintain the temperature of the CO shift catalyst at 350° C. or below by controlling the cooling means. This is because with this configuration, the CO shift catalyst for purification of coal-gasified gas containing Mo can be used for a long time.

Next, another embodiment of the CO shift reaction apparatus according to the present invention and a CO shift reaction method which uses the CO shift reaction apparatus, which are different from those of the above-described embodiment, will be described in detail below.

The CO shift reaction apparatus is configured to at least include a plurality of adiabatic reactors, at least one heat exchanging means, at least one steam supply means, and at least one gas pipe.

The adiabatic reactor at least includes a gas inlet for introducing gas into the reactor, a CO shift catalyst layer filled with the CO shift catalyst and through which the introduced gas passes, and a gas outlet for discharging the gas which has passed through the CO shift catalyst layer to the outside of the reactor. If a CO shift reaction is completed by using one adiabatic reactor only, the temperature of the CO shift catalyst may become excessively high due to the exothermal reaction. In order to prevent this, the present embodiment employs a configuration in which the CO shift reaction is run in a distributed manner among a plurality of adiabatic reactors to prevent the temperature of the CO shift catalyst in the respective adiabatic reactors from becoming excessively high.

The heat exchanging means may be means configured to cool the gas that has been heated during the CO shift reaction to a high temperature, and examples of such means include a heat exchanger, etc. The gas cooled by the heat exchanging means is introduced through the gas inlet into an adiabatic reactor different from the above-described adiabatic reactor through the gas pipe which connects the adiabatic reactors in series, and a next CO shift reaction is promoted by the gas which has passed through the CO shift catalyst layer.

The gas to be reformed, the CO shift catalyst, and the steam supply means are as described above.

In addition, the CO shift reaction apparatus may also include apparatuses and means such as measuring instruments (a temperature sensor, a concentration sensor, and a pressure sensor), a CO shift reactor for backup, and an apparatus configured to supply nitrogen, which is to be used when abnormality occurs.

With respect to the CO shift reaction method which uses the CO shift reaction apparatus described above, it is preferable to control the CO shift reaction, which is an exothermal reaction, by adjusting the amount of steam to be supplied to the CO shift catalyst layer by using the steam supply means and to maintain the temperature of the CO shift catalyst at 350° C. or below by cooling the gas discharged through the gas outlet to 350° C. or below by using the heat exchanging means. This is because with this configuration, the CO shift catalyst for purification of the coal-gasified gas containing Mo can be used for a long time.

Now, the entire CO shift process and embodiments of the CO shift reaction apparatus, and the CO shift reaction method according to the present invention will be described in detail below with reference to the attached drawings. Note that the embodiments of the present invention are not limited to those illustrated in the respective drawings.

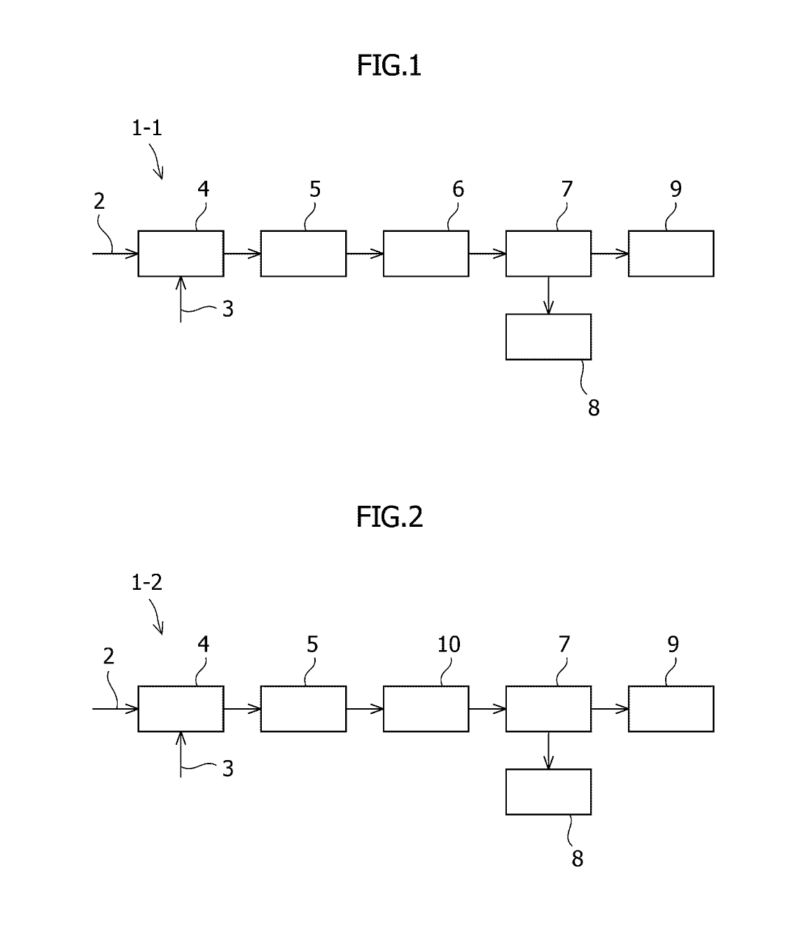

FIG. 1 is an outline drawing which illustrates the entire gas purification process 1-1. In this process, at first, coal 2 is gasified by a gasification furnace 4 in the presence of oxygen 3. After the resultant gas is dedusted by a dedusting apparatus 5, a CO shift reaction is run in a CO shift reaction apparatus 6, and then H₂S and CO₂ is recovered from the gas by an H₂S and CO₂ recovery apparatus 7. Then synthesis of chemicals 8 for synthesizing methanol, ammonium, etc. is carried out or power generation 9 is carried out by introducing gas or steam into the gas turbine or the steam turbine.

FIG. 2 is an outline drawing which illustrates the entire gas purification process of another embodiment different from that illustrated in FIG. 1. In this process, the same steps as those of the process illustrated in FIG. 1 are performed up to the gas dedusting step, then COS is converted into H₂S by a COS conversion apparatus 10, then H₂S and CO₂ are recovered by the H₂S and CO₂ recovery apparatus 7, and then a CO shift reaction is run in the CO shift reaction apparatus 6. After that, the synthesis of chemicals 8 or the power generation 9 is carried out similarly to the embodiment illustrated in FIG. 1.

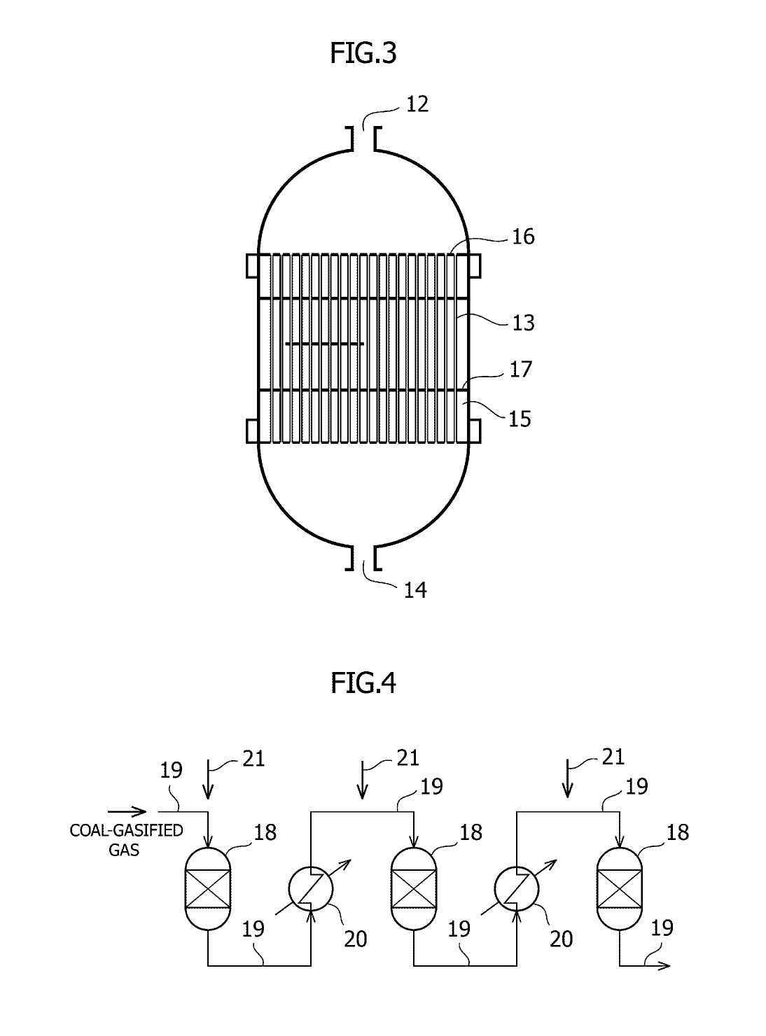

FIG. 3 is a cross section which illustrates an embodiment of the CO shift reaction apparatus 6 used in the CO shift process illustrated in each of FIGS. 1 and 2. The CO shift reaction apparatus includes a gas inlet 12, a CO shift catalyst layer 13, a gas outlet 14, and water 15 as its basic configuration, and further includes a tube plate 16 and a baffle 17 for reinforcing the CO shift catalyst layer 13.

The gas to be reformed is introduced through the gas inlet 12 into the reaction apparatus, then the CO shift reaction is promoted in the CO shift catalyst layer 13 which includes a tubular reaction tube filled with the CO shift catalyst, and then the gas is discharged through the gas outlet 14 to the outside of the reaction apparatus. The water 15 circulates in the periphery of the CO shift catalyst layer 13 so as to cool the CO shift catalyst layer 13. The steam necessary for the CO shift reaction is introduced through the gas inlet 12 into the reaction apparatus together with the gas. The temperature of the CO shift catalyst can be adjusted by controlling the amount of circulation of the water 15 according to the progress of the CO shift reaction.

FIG. 4 is a schematic diagram which illustrates a CO shift reaction apparatus which uses adiabatic reactors according to an embodiment different from that illustrated in FIG. 3. A plurality of adiabatic reactors 18 is serially connected by respective gas pipes 19, and the heat exchanging means 20 is provided in the middle of the respective gas pipe.

After the high temperature gas is discharged from the adiabatic reactor, the gas is cooled by the heat exchanging means during its introduction into a next adiabatic reactor through the gas pipe. Steam 21 is supplied from the steam supply means into the gas pipe provided between heat exchanging means 20 and an adiabatic reactor 18 to introduce the gas into the adiabatic reactor 18.

FIG. 5 is a schematic diagram illustrating a CO shift reaction apparatus which uses an adiabatic reactor according to an embodiment different from that of the present invention. Unlike the embodiment illustrated in FIG. 4, the embodiment illustrated in FIG. 5 has a configuration in which a CO shift reaction is completed by using one adiabatic reactor 18 only, and accordingly, the temperature of the CO shift catalyst may become excessively high due to the exothermal reaction, which may result in adversely affecting the life of the CO shift catalyst.

### EXAMPLES

Now, the present invention will be described in detail below with reference to examples and a comparative example; however, the present invention is not limited by the following examples at all.

### [Production of the CO Shift Catalyst]

100 g of titanium dioxide (TiO₂) (“MC-90”, a product of Ishihara Sangyo Kaisha, Ltd.) was placed on a porcelain plate, then nickel nitrate•hexahydrate and ammonium molybdate•tetrahydrate, respectively dissolved in 150 mL water, were added, so that 5 wt. % NiO and 15 wt. % MoO in relation to the total amount of powder to be finally obtained were to be carried, and then the mixture was evaporated, dried, and impregnated on the porcelain plate. After having completely dried the resultant powder, the powder was burned at 500° C. for 3 hours (the rate of temperature increase: 100° C./h) to obtain a powder catalyst.

The powder was immobilized in a 30-ton pressure molding apparatus and crushed so that the particle diameter ranged from 2 to 4 mm, then the resultant was filtered to obtain a Ni—Mo/TiO₂ catalyst.

### Example 1

The evaluation was performed by using the CO shift reaction apparatus illustrated in FIG. 3. A tubular reaction tube was filled with a CO shift catalyst, and in running a CO shift reaction, the water 15 was allowed to circulate around the periphery of the tubular reaction tube to perform water-cooling. The gas to be reformed was introduced through the gas inlet into the reactor together with steam, and the CO conversion rate was calculated by using the following Expression (3) on the basis of the difference (variation) between the flow rate at the gas inlet and that at the gas outlet of CO gas introduced through the gas inlet and discharged through the gas outlet. The composition of the mixture of the gas and the steam to be introduced into the reactor was as follows: H₂/CO/CO₂/H₂O=17/24/11/48 mol %, the gas hourly space velocity (GHSV) (the amount of gas per unit catalyst amount)=3,000 h⁻¹, H₂S=20 ppm, S/CO=1.0; and the pressure of the gas was 0.9 MPa and the temperature of the gas was 250° C.

The life of the CO shift catalyst was evaluated by dividing the CO conversion rate after the gas was circulated for 2,000 hours by the CO conversion rate at the start of the circulation of gas. The temperature of the CO shift catalyst was evaluated by measuring the temperature of the CO shift catalyst layer. In addition, in order to analyze the amount of carbonaceous substances deposited on the catalyst, a quantitative analysis on the carbonaceous substances on the catalyst was performed by using a simultaneous carbon/sulfur analyzer.

[Expression 3]

CO conversion rate (%)=(1−CO gas flow rate at gas outlet (mol/h)/CO gas flow rate at gas inlet (mol/h))×100 (3)

### Example 2

Three adiabatic reactors 18 of the CO shift reaction apparatus illustrated in FIG. 4, respectively filled with the CO shift catalyst, were arranged for the test. The gas to be reformed was mixed with the steam 21 in the gas pipe 19, then the gas was introduced through the gas inlet into the first adiabatic reactor to run a CO shift reaction, then the resultant was mixed with new steam 21, and then the mixture was discharged through the gas outlet through the gas pipe and introduced into a next adiabatic reactor through its gas inlet. After the high temperature gas was discharged from the second adiabatic reactor, the gas was cooled by the heat exchanging means 20 during its introduction into a next adiabatic reactor through the gas pipe, and the temperature of the CO shift catalyst of the respective adiabatic reactors was maintained there at 350° C. or below. The same conditions as those in Example 1 were set for the composition of the mixture of the gas and the steam, the pressure of the gas, the temperature of the gas, and the method of measuring the temperature of the CO shift catalyst, and the catalysts were filled into the respective adiabatic reactors so that the GHSV for the total amount of catalysts filled into the three adiabatic reactors became 3,000 h⁻¹. In addition, the CO conversion rate was calculated by using the following Expression (3) on the basis of the difference (variation) between the flow rate of CO gas at the gas inlet of the first adiabatic reactor into which the CO gas was to be introduced first and that of the CO gas at the gas outlet of the last adiabatic reactor from which the gas was to be discharged last. The life of the CO shift catalyst was evaluated in the similar manner as that in Example 1 by dividing the CO conversion rate after the gas was circulated for 2,000 hours by the CO conversion rate at the start of the circulation of gas.

In addition, in order to analyze the amount of carbonaceous substances deposited on the catalyst, a quantitative analysis on the carbonaceous substances deposited on the catalyst was performed by using a simultaneous carbon/sulfur analyzer.

### Comparative Example 1

Unlike Example 2, a CO shift reaction was run by using one adiabatic reactor 18 only and without using any cooling means or heat exchanging means. The same conditions as those in Example 2 were set for the amount of CO shift catalyst to be filled into the respective adiabatic reactors, the composition of the mixture of the gas and the steam, the pressure of the gas, and the temperature of the gas. In addition, the same methods as those used in Example 1 were used for the method of evaluating the life of the CO shift catalyst, the method of measuring the temperature of the CO shift catalyst, and the method of calculating the amount of carbonaceous substances deposited on the CO shift catalyst.

TABLE 1

| | CO conversion rate | Amount of |
|---|---|---|
| | after 2,000 hours of | increased |
| | circulation of gas/ | carbonaceous |
| | CO conversion | substances |
| | rate at the start | deposited on the |
| | of the circulation | catalyst (wt. %) |
| Example 1 | 0.95 | 0.6 |
| Example 2 | 0.91 | 0.8 |
| Reference | 0.77 | 2.1 |
| Example 1 | | |

Table 1 illustrates results of the tests, such as values calculated by dividing the CO conversion rate after circulating the gas for 2,000 hours in the respective Examples by the CO conversion rate at the start of the circulation of the gas and the amount of increased carbonaceous substances deposited on the catalyst after the CO shift reactions were run for 2,000 hours. In Examples 1 and 2, the degradation of the CO conversion rates were very small and the amount of the deposited carbonaceous substances was small compared with Comparative Example 1, and as a result, it was observed that the deposition of carbonaceous substances was suppressed and the life of the catalyst was prolonged.

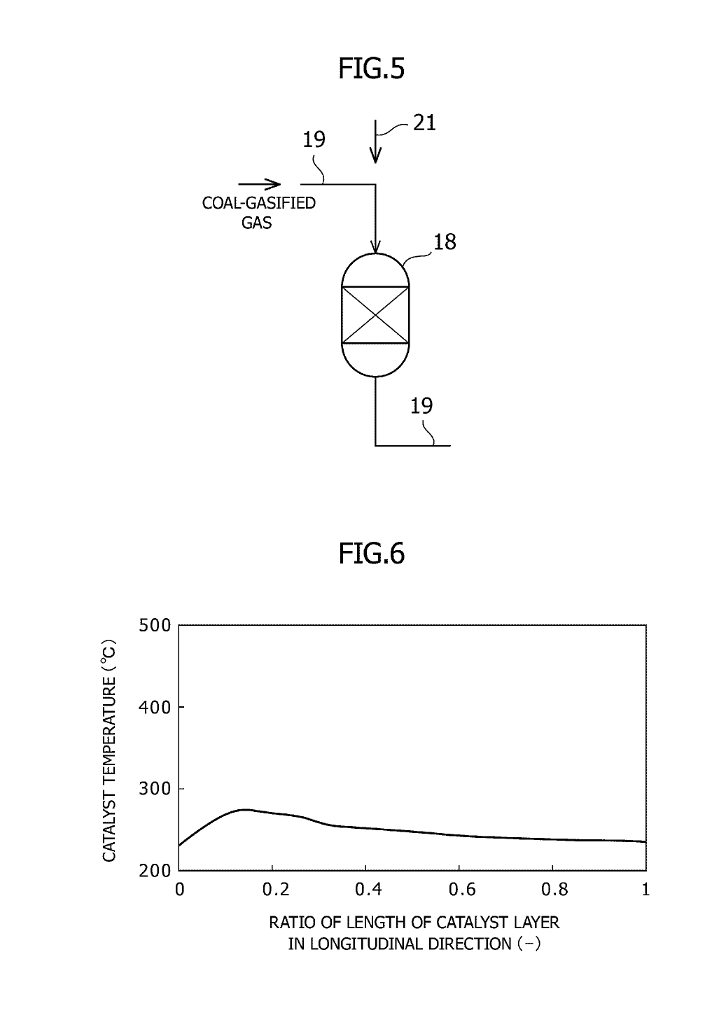

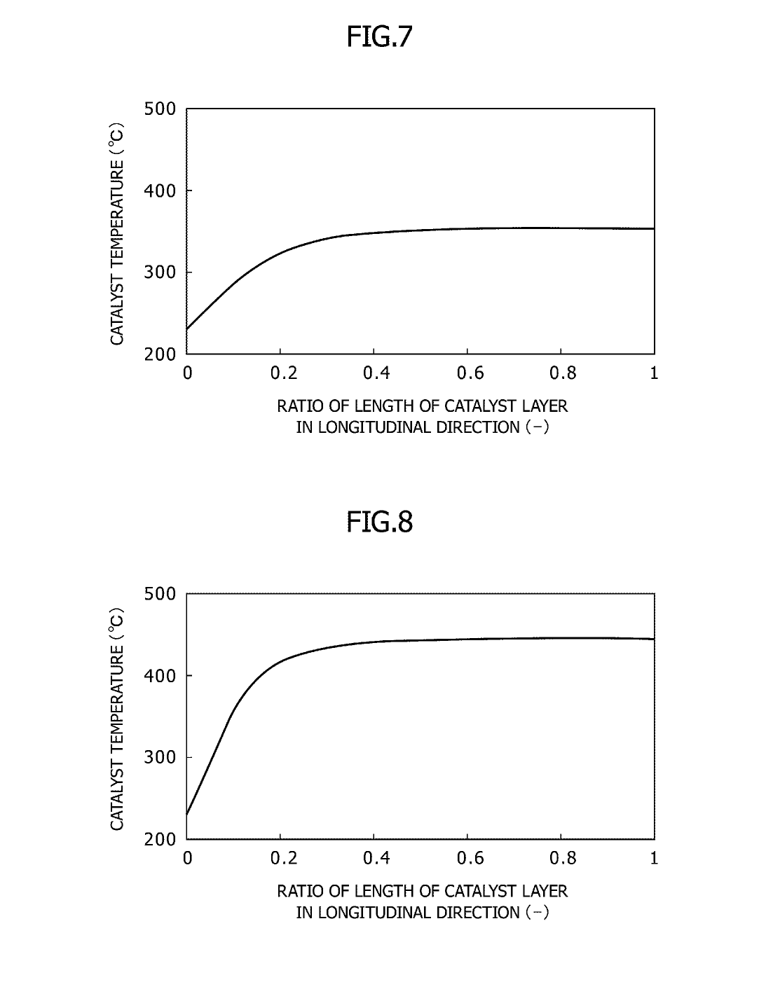

FIGS. 6 to 8 illustrate the results of measurement of the temperatures of the CO shift catalysts used in Examples 1 and 2 and Comparative Example 1. The temperature corresponding to the value “0” on the axis of abscissa denotes the temperature of the catalyst in the first portion of the CO shift catalyst layer in which the gas to be reformed having been introduced through the gas inlet is allowed to start contacting (entering into) the CO shift catalyst layer, and the temperature corresponding to the value “1” on the axis of abscissa denotes the temperature of the catalyst in the last portion of the CO shift catalyst layer from which the gas having been heated in the CO shift catalyst layer exists. In Examples 1 and 2, the temperature of the catalyst was maintained at 350° C. or below (FIGS. 6 and 7); while in Comparative Example 1, the temperature of the catalyst rose to a temperature as high as 450° C. due to the CO shift reaction, i.e., an exothermal reaction (FIG. 8).

According to the results illustrated in Table 1 and FIGS. 6 to 8, it was apparent that the life of the respective catalysts was prolonged by maintaining the catalyst temperature at 350° C. or below.

### INDUSTRIAL APPLICABILITY

According to the CO shift reaction apparatus of the present invention and the CO shift reaction method which uses the CO shift reaction apparatus, degradation of catalytic activity can be suppressed, which may occur due to the deposition of carbonaceous substances on CO shift catalysts for purification of coal-gasified gas containing Mo, and thus, the life of the catalyst can be prolonged; therefore, the present invention is useful for industrial application.

### REFERENCE SIGNS LIST

1-1 Gas purification process

1-2 Gas purification process

2 Coal

3 Oxygen

4 Gasification furnace

5 Dedusting apparatus

6 CO shift reaction apparatus

7 H₂S/CO₂ recovery apparatus

8 Synthesis of chemicals

9 Power generation

10 COS conversion apparatus

12 Gas inlet

13 CO shift catalyst layer

14 Gas outlet

15 Water

16 Tube plate

17 Baffle

18 Adiabatic reactor

19 Gas pipe

20 Heat exchanging means

21 Steam

1. (canceled)

2. (canceled)

3. (canceled)

4. (canceled)

5. A CO shift reaction apparatus configured to reform carbon monoxide contained in gas, the reaction apparatus at least comprising:
a CO shift catalyst containing molybdenum and nickel is supported by titanium dioxide;
an adiabatic reactor comprising:
a gas inlet for introducing gas;
a CO shift catalyst layer filled with the CO shift catalyst and through which the introduced gas passes; and
a gas outlet for discharging the gas which has passed through the CO shift catalyst layer;
a heat exchanging means configured to cool the gas discharged through the gas outlet; and
a one steam supply means configured to supply steam to the CO shift catalyst layer;
wherein the temperature of the CO shift catalyst is maintained at 350° C. or below.

6. (canceled)

7. (canceled)

8. A CO shift reaction method which uses the CO shift reaction apparatus according to claim 5, wherein a CO shift reaction is controlled by adjusting an amount of steam to be supplied to the CO shift catalyst layer by using the steam supply means and the temperature of the CO shift catalyst is maintained at 350° C. or below by cooling the gas by using the heat exchanging means so that the gas discharged through the gas outlet becomes 350° C. or below.

9. The CO shift reaction apparatus according to claim 5, wherein a plurality of the adiabatic reactors are connected by the gas pipes in series.

10. A CO shift reaction method which uses the CO shift reaction apparatus according to claim 9, wherein a CO shift reaction is controlled by adjusting an amount of steam to be supplied to the CO shift catalyst layer by using the steam supply means and the temperature of the CO shift catalyst is maintained at 350° C. or below by cooling the gas by using the heat exchanging means so that the gas discharged through the gas outlet becomes 350° C. or below.
